(19) United States
(12) Patent Application Publication
(10) Pub. No.: US 2004/0221688 A1
(43) Pub. Date: Nov. 11, 2004

(54) Socket for a wrench

(76) Inventor: Hui-Chen Liao, Taichung (TW)

Correspondence Address: Alan D. Kamrath, Rider Bennett, LLP, 333 South Seventh Street, Suite 2000, Minneapolis, MN, 55402, US

(21) Appl. No.: 10/429,650

(22) Filed: May 5, 2003

(51) Int. Cl. B25B 13/06

(52) U.S. Cl. 81/121.1

(57) ABSTRACT

A socket for a wrench has a body with a central hole defined in one end of the body and a connecting device formed on the second end of the body. Multiple protrusions are formed on the inner surface of the central hole. Each protrusion has a peak and multiple teeth formed on one side of the protrusion. With such a socket, the socket can securely hold the head of the fastener with the teeth on the protrusions even when the head has been worn away.

### BACKGROUND OF THE INVENTION

1. Field of the Invention

The present invention relates to a socket, and more particularly to a socket for a wrench and that can securely hold a head of a fastener to rotate the fastener even when the head has been worn away.

2. Description of Related Art

A socket can be attached to a wrench to hold and to rotate a fastener, such as a bolt or a nut. A conventional socket has a body with a central hole defined in one end of the body. A square hole is defined in the other end of the body to engage with a cubic stub protruding from the wrench, such that the socket can rotate with the wrench by means of the engagement between the stub and the hole. The central hole is polygonal and generally has six identical surfaces forming the central hole. The polygonal central hole can engage with a polygonal head of the fastener to drive the fastener to rotate with the socket so as to tighten or loosen the fastener relative to an object.

However, the central hole of the conventional socket cannot securely hold a head of a fastener when the head has been worn away. The worn head cannot be driven to rotate with the conventional socket, and so the use of the conventional socket is limited and is not versatile.

To overcome the shortcomings, the present invention tends to provide a socket to mitigate or obviate the aforementioned problems.

### SUMMARY OF THE INVENTION

The main objective of the invention is to provide a socket for a wrench and that can drive a head of a fastener even when the head has been worn away. The socket has a body with a central hole defined in one end of the body and a connecting device formed on the second end of the body. Multiple protrusions are formed on the inner surface of the central hole. Each respective protrusion has a peak and multiple teeth formed on one side of the protrusion. In such an arrangement, the socket can securely hold the head of the fastener with the teeth on the second protrusions.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view in partial cross section of an object with a fastener, a wrench and a socket in accordance with the present invention;

FIG. 2 is a top plan view in partial cross section of the fastener, the wrench and the socket in FIG. 1;

FIG. 3 is an operational side plan view in partial cross section of the object with the fastener, the wrench and the socket in FIG. 1;

FIG. 4 is a top plan view in partial cross section of the socket engaging with the head of the fastener in FIG. 1;

FIG. 5 is a top plan view in partial cross section of the socket in FIG. 1 engaging with a worn head; and

FIG. 6 is an exploded perspective view in partial cross section of an object with a fastener, a wrench and another embodiment of a socket in accordance with the present invention.

### DETAILED DESCRIPTION OF PREFERRED EMBODIMENT

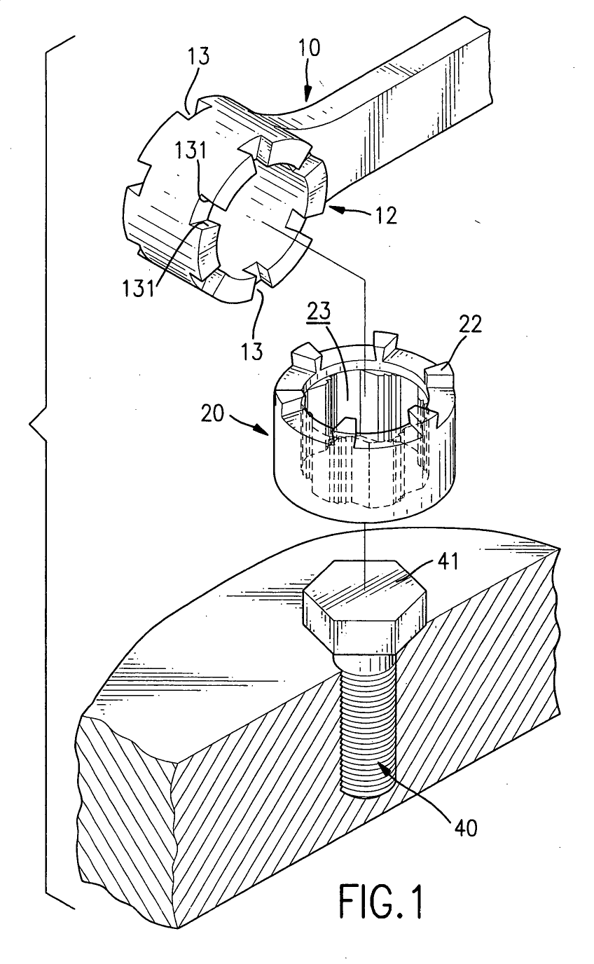

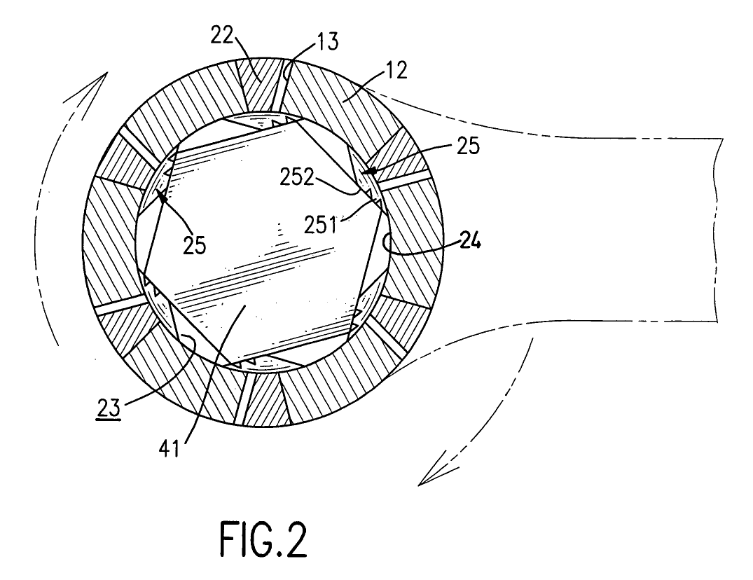

With reference to FIGS. 1 and 2, a socket (20) for a wrench (10) in accordance with the present invention comprises a body and a connecting device. The body has a first end, a second end and a central hole (23) with an inner surface defined in the first end. In a first embodiment, the central hole (23) is defined through the body from the first end to the second end. Multiple protrusions (25) are formed on the inner surface defining the central hole (23). A gap (24) is defined between each respective pair of adjacent protrusions (25). Each respective protrusion (25) has a peak (not numbered) and multiple teeth (251) formed on one side of the second protrusion (25). Each respective tooth (251) on each second protrusion (25) has a flat free end (252). A dent (not numbered) is defined between each pair of adjacent teeth (251) on each protrusion (25), and each dent has two inner surfaces inclined with each other at an angle in a range from 57° to 61°. In addition, one of the teeth (251) on each protrusion (25) is formed adjacent to the peak of the protrusion (25).

The connecting device is formed on the second end of the body and is adapted to connect to the wrench (10). The connecting device comprises multiple engaging blocks (22) protruding from the second end of the body. Each engaging block (22) has two surfaces inclined with each other.

In practice, a tubular connecting head (12) is formed on end of the wrench (10), and multiple engaging recesses (13) are respectively defined in two sides of the connecting head (12) and respectively correspond to the engaging blocks (22) on the socket (20). Each engaging recess (13) has two inclined surfaces (131) respectively corresponding to the inclined surfaces on the corresponding engaging block (22). The engaging recesses (13) have a width larger than that of the engaging block (22), such that a gap is defined between each engaging recess (13) and the corresponding engaging block (22).

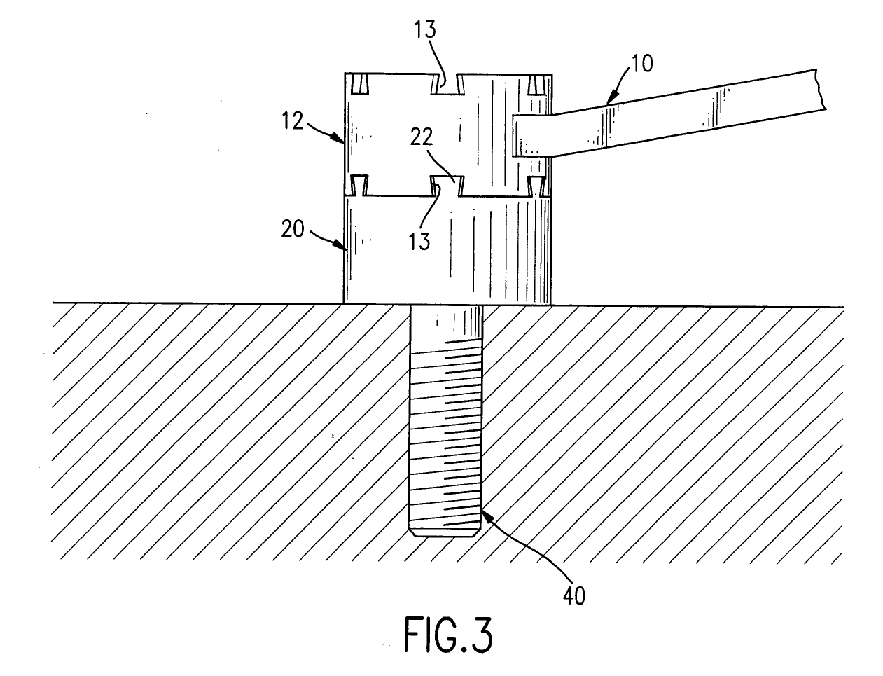

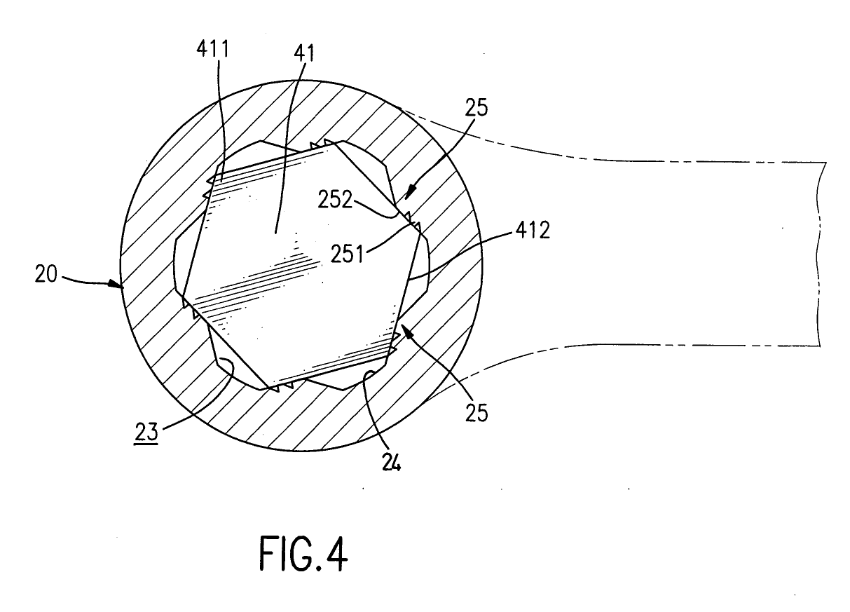

With reference to FIGS. 2 to 4, to tighten or to loosen a fastener (40) with a polygonal head (41), the socket (20) is mounted onto the fastener (40) by the central hole (23) receiving the head (41). Corners (411) of the head (41) are respectively received in the gaps between the second protrusions (25) and the first protrusions (26). The teeth (251) on the protrusions (25) abut against edges (412) of the head (41) with the flat free ends (252). With the abutment between the teeth (251) on the socket (20) and the edges (412) of the head (41), the socket (20) can securely hold the head (41) in the central hole (23). Then, the wrench (10) is attached to the socket (20) with the engaging blocks (22) engaging with the engaging recesses (13) in the connecting head (12). Consequently, the fastener (40) is driven to rotate when the wrench (10) is rotated, and the fastener (40) will be tightened on or loosened from an object (not numbered). In addition, because the corners (411) of the head (41) of the fastener (40) are received in the gaps between the protrusions (25), wear of the corners (411) of the head (41) is prevented.

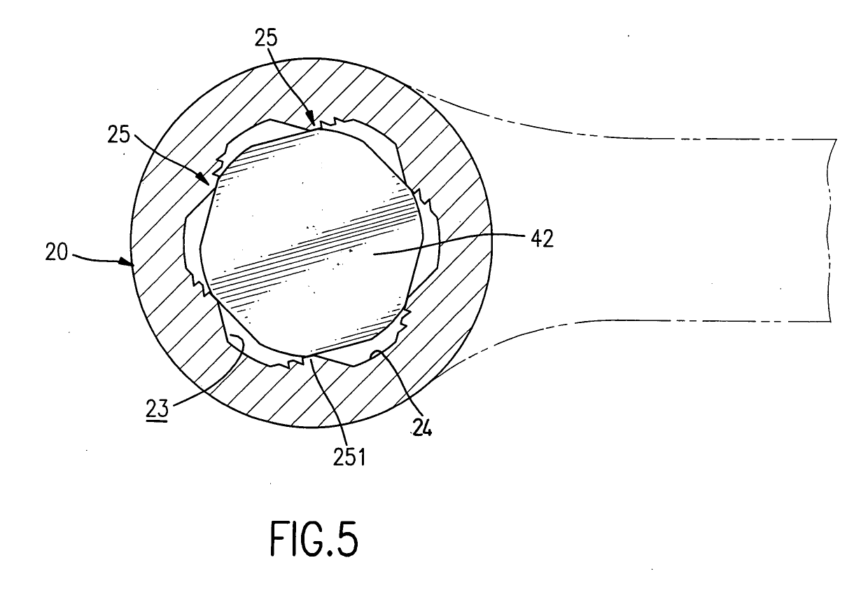

With reference to FIG. 5, when the socket (20) is applied to rotate a fastener with a worn head (42), the flat free end (252) of the tooth (251) near the peak of each protrusion (25) will still abut against the outer periphery of the worn head (42). The worn head (42) can be securely held and driven to rotate by the socket (20) in accordance with the present invention. Therefore, the socket (20) in accordance with this present invention can be used to fastener with a worn head (42) even when the head (42) has worn away to a round head.

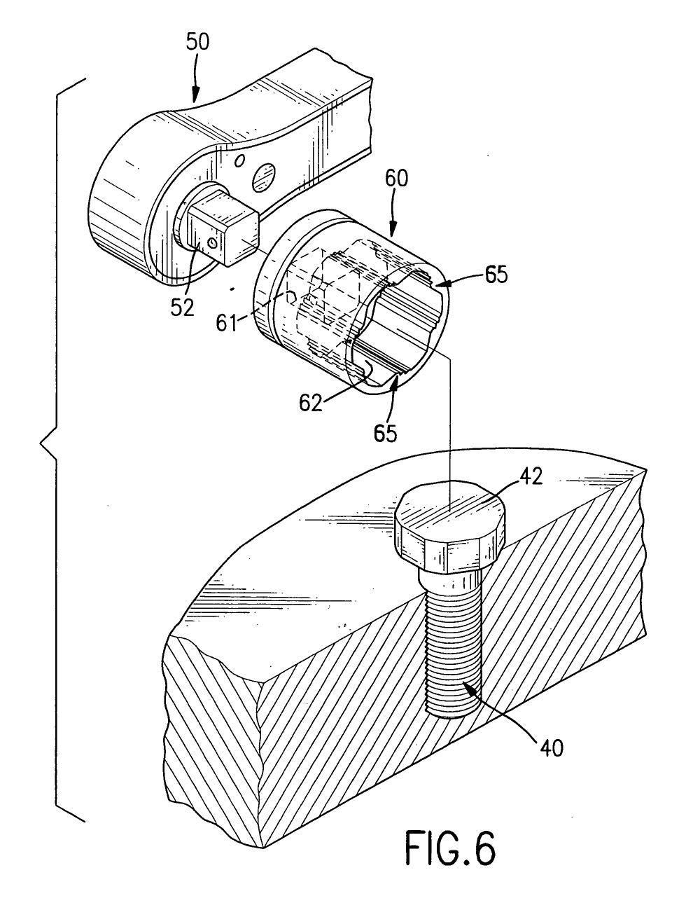

In a second embodiment, with reference to FIG. 6, the socket (60) comprises a body and a connecting device. The body has a first end, a second end and a central hole (62) defined in the first end. Multiple protrusions (65) with teeth are formed on the inner surface of the central hole (62). The protrusions (65) of this embodiment are same as those of the first embodiment and are not further described. The connecting device is formed on the second end of the body and comprises a wall (not numbered) and a substantially square hole (61). The wall is formed on the second end of the body, and the square hole (61) is defined through the wall and communicates with the central hole (62) in the body. The square hole (61) can fit with a cubic stub (52) protruding from a connecting head of a wrench (50) to make the socket rotate with the wrench. With the arrangement of the protrusions (65), the socket (60) can be used to drive a fastener (40) with a worn head (42).

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A socket for a wrench comprising:
a body having an axial length, a first end and a second end along the axial length, with the body having a central hole extending from the first end, with the central hole having an inner surface defined in the first end of the body;
a connecting device formed on the second end of the body to be adapted to connect to the wrench;
multiple protrusions formed on the inner surface of the central hole, with the multiple protrusions spaced circumferentially and extending longitudinal the body, with each protrusion of the multiple protrusions having a peak, a first side and a second side, with the peak formed by the interconnection of the first side and the second side, with the first and second sides each being planar and at an obtuse angle to each other;
a gap defined between each pair of adjacent protrusions; and
multiple longitudinal notches formed in the first side of each provision, with the multiple notches being circumferentially spaced from each other and the peak of each protrusion and from the gap, with the multiple longitudinal notches defining multiple teeth, wherein each tooth on each protrusion is truncated to define a flat free end, with the flat free ends of the multiple teeth on each protrusion cooperating to define the first side, with the flat free end of one of the multiple teeth of each protrusion located at and forming the peak.

2. The socket as claimed in claim 1, wherein each notch has two inner planar surfaces inclined with each other at an angle in a range from 57° to 61°.

3. (cancelled)

4. The socket as claimed in claim 1, wherein the second end has an opening and the central hole is defined through the body from the first end to the opening in the second end; and
the connecting device comprises multiple engaging blocks spaced circumferentially and protruding longitudinally from the second end of the body radially exterior a perimeter of the central hole, with each engaging block of the multiple engaging blocks having two surfaces located opposite each other circumferentially and inclined with each other, with cross sections perpendicular to the axial length of each engaging block having a radial inside width between the two surfaces narrower than a radial outside width between the two surfaces.

5. The socket as claimed in claim 4, further comprising:
a connecting head that defines multiple engaging recesses, with the connecting head having a center hole of a size corresponding to the inner surface of the body, with the multiple engaging recesses being radially exterior the center hole and spaced circumferentially to correspond with the multiple engaging blocks, with each engaging recess of the multiple engaging recesses having two inclined surfaces inclined with each other and located opposite each other circumferentially, with cross sections perpendicular to the axial length of each engaging recess having a radial inside width between the two inclined surfaces narrower than a radial outside width between the two inclined surfaces, with the radial inside and outside widths of the cross sections of each engaging recess being larger than the radial inside and outside widths respectively of the cross sections of each engaging block to facilitate receiving the multiple engaging blocks into the multiple engaging recesses.

6. The socket as claimed in claim 1, wherein the connecting device comprises a wall formed on the second end of the body and a square hole defined through the wall and communicating with the central hole in the body, with the connecting device adapted to connect with a cubic stub protruding from a connecting head of the wrench.
